(19) United States
(12) Patent Application Publication
(10) Pub. No.: US 2025/0063453 A1
(43) Pub. Date: Feb. 20, 2025

(54) FAST 5G BEAM SWITCHING BY EARLY MEASUREMENT REPORTING

(71) Applicant: GOOGLE LLC, Mountain View, CA (US)

(72) Inventors: Edison Chen, Taipei (TW); Yuan Ho, Hsinchu City (TW); Poying Chuang, Taipei (TW)

(21) Appl. No.: 18/721,540

(22) PCT Filed: Dec. 19, 2022
(86) PCT No.: PCT/US2022/053363

§ 371 Date: Jun. 18, 2024

Related U.S. Application Data
(60) Provisional application No. 63/291,794, filed on Dec. 20, 2021.

(51) Int. Cl. H04W 36/30; H04B 7/06; H04W 24/10; H04W 36/06

(52) U.S. Cl. CPC H04W 36/305; H04B 7/0695; H04W 24/10; H04W 36/06

(57) ABSTRACT

A user equipment (UE) in a wireless communication network determines that a radio link failure (RLF) has previously occurred within a threshold distance from a current location of the UE. Responsive to determining that the RLF has previously occurred, the UE determines an expected beam to be encountered and that is associated with the RLF. The UE generates a first beam measurement report for the expected beam. The beam measurement report includes an adjusted power measurement for the expected beam indicating that the expected beam is an optimal beam compared to at least one neighboring beam. The UE transmits the first beam measurement report to the cellular network.

### BACKGROUND

The use of millimeter-wave (mmWave) bands and higher-frequency bands in cellular networks has the potential for higher data rates and lower latencies through increased channel bandwidths compared to lower-frequency bands. However, the mobile environment at these high frequencies is considerably more complex than at lower frequencies, with disproportionally higher propagation/path losses, decreased resiliency and robustness, and susceptibility to line of sight (LoS) blockage by materials and objects in the local environment. Accordingly, cellular protocols that support the use of mmWave bands, such as the Fifth Generation (5G) New Radio (NR) cellular protocols promulgated by the Third Generation Partnership Project (3GPP), rely on the use of highly directional communication links between a base station (BS) and the user equipment (UE) served by the BS to leverage the focused gain provided by such communication links. Leveraging the relatively large number of relatively small antenna elements that can be implemented at mmWave and higher-frequency bands, mobile UEs utilize high-dimensional phased antenna arrays to provide highly directional communication links. However, these directional links often require precise alignment between the transmitter and receiver beams. Accordingly, one mmWave-capable BS often also employs beamforming processes to facilitate beam alignment between the BS and an attached UE, thereby allowing the BS and the UE to leverage the narrower transmit and receive beams to reduce the degree of radio interference while maintaining sufficient signal power at longer distances.

### SUMMARY OF EMBODIMENTS

In accordance with some embodiments, a method by a user equipment (UE) in a cellular network includes determining that a radio link failure (RLF) has previously occurred within a threshold distance from a current location of the UE. Responsive to determining that the RLF has previously occurred, an expected beam to be encountered by the UE and associated with the RLF is identified or determined. A first beam measurement report is generated for the expected beam. The first beam measurement report includes an adjusted power measurement for the expected beam. The first beam measurement report is transmitted to the cellular network.

In various embodiments, the method includes one or more of the following aspects. The expected beam is determined further in response to determining that a current route of the UE substantially corresponds to route information recorded by the UE when the RLF previously occurred. The first beam measurement report is generated and transmitted to the cellular network during a time interval that is prior to a time interval during which a beam measurement report for the expected beam is generated and transmitted when the RLF has not occurred. Generating the first beam measurement report includes one of: increasing an original power measurement by a predefined incremental value to obtain the adjusted power measurement; increasing the original power measurement by a predefined maximum value to obtain the adjusted power measurement; or increasing the original power measurement by a fixed value to obtain the adjusted power measurement. Generating the first beam measurement report includes adjusting the adjusted power measurement for the expected beam to indicate that the expected beam is more optimal than neighboring beams. The method further includes, responsive to transmitting the first beam measurement report to the cellular network, determining a base station has indicated a beam switch to the expected beam, and changing a receive beam to the expected beam. The method also includes, responsive to determining that a base station has not indicated a beam switch, checking an accuracy of the first beam measurement report. Checking the accuracy of the first beam measurement report includes increasing a measurement frequency of the expected beam. Increasing a measurement frequency of the expected beam includes reducing a number of synchronization signal blocks measured by the UE. Increasing a measurement frequency of the expected beam includes initiating a timer and performing one or more power measurements for the expected beam prior to expiration of the timer. The method further includes responsive to the accuracy of the first beam measurement report satisfying one or more conditions, generating a second beam measurement report for the expected beam, the second beam measurement report also including a further adjusted power measurement for the expected beam; and transmitting the second beam measurement report to the cellular network. The method further includes responsive to the accuracy of the first beam measurement report failing to satisfy one or more conditions, generating a second beam measurement report for the expected beam comprising an original power measurement for the expected beam; and transmitting the second beam measurement report to the cellular network. The one or more conditions include a condition that a power measurement of the expected beam is increasing.

In some embodiments, a user equipment is configured to implement any of the methods described above and herein.

In some embodiments, a non-transitory computer-readable medium stores executable instructions configured to manipulate a processor of a user equipment to implement any of the methods described above and herein.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1 is a diagram illustrating an example wireless communication system employing a user equipment (UE) implementing one or more early beam measurement reporting mechanisms in accordance with some embodiments.

FIG. 2 is a diagram illustrating a base station performing late switching to an optimal beam resulting in a UE experiencing a radio link failure in accordance with some embodiments.

FIG. 3 is a diagram illustrating a UE avoiding the radio link failure condition of FIG. 2 by performing early beam measurement reporting to the base station in accordance with some embodiments.

FIG. 4 is a diagram illustrating an example configuration of a UE of the wireless communication system of FIG. 1 in accordance with some embodiments.

FIG. 5 is a diagram illustrating an example configuration of a base station of the wireless communication system of FIG. 1 in accordance with some embodiments.

FIG. 6 is a diagram illustrating an example method of a UE performing early beam measurement reporting to a base station for preventing radio link failure in accordance with some embodiments.

FIG. 7 is a flow diagram illustrating an example implementation of an early beam measurement report accuracy check subprocess of the method of FIG. 6 in accordance with some embodiments.

### DETAILED DESCRIPTION

A 5G NR mobile network typically implements beamforming technology to establish highly directional transmission links in the mmWave bands. Beamforming involves the transmitting device, such as a base station or a UE, shaping a signal and turning the shaped signal into a concentrated beam aimed at a receiving device, such as a base station or UE. Rather than sending signals in multiple directions at once, which increases signal loss, beamforming creates streamlined signal paths by applying relative amplitude and phase shifts to antenna elements so that signals sent in undesired directions destructively interfere with each other. Beam management operations are typically performed by the BS and UE to maintain alignment of the transmitter and receiver beams and to perform various control tasks including initial access (IA) for idle users, which allows a UE to establish a physical link connection with the BS, and beam tracking for connected users, which enables beam adaptation schemes or procedures such as handover, path selection, and radio link failure (RLF) recovery. Beam management operations include beam sweeping, beam measurement, beam determination, and beam reporting. Beam sweeping involves the BS covering a spatial area with a radiating pattern using a multi-directional beam sweep during pre-specified time intervals. Beam measurement involves the UE (or BS) evaluating the quality of the received signal (beam). Beam determination involves the UE (or BS) selecting a suitable beam(s). Beam reporting involves the UE providing feedback to the BS regarding beam quality and decision information regarding the beam(s) selected by the UE.

During the connected mode, the UE and BS perform beam management operations to maintain alignment of the transmitter and receiver beams as the UE moves throughout the mobile network. For example, the BS typically sends a request to the UE to perform one or more measurements on detected beams and provide these measurements back to the BS via one or more reports. However, a UE is typically mobile and moves through different beam coverage areas and overlapping coverage areas. Based on conventional beam reporting mechanisms, the UE may report a sub-optimal beam to the BS even though the UE is moving into a coverage area of a more optimal beam. As such, by the time the mobile UE sends a new beam measurement report to the BS identifying the new optimal beam, the beam switch performed by the BS may be too late, and the UE will experience an RLF.

Accordingly, described herein are example systems and techniques for UE early beam measurement reporting for avoiding RLFs due to late BS beam switching. In at least some embodiments, the UE monitors for RLFs and records beam information and geographical information associated with a detected RLF. As the UE travels throughout the network, the UE detects when it is at (or near) a location where an RLF previously occurred. The UE also determines if it is moving along the substantially same route/path as when the RLF occurred. When the UE determines that its current location/route corresponds to a previous location/route associated with an RLF, the UE determines the next beam to be encountered along the route and generates an early beam measurement report. In at least some embodiments, the UE adjusts the measurement (e.g., a radio signal received power (RSRP) measurement) of the expected beam and includes the adjusted measurement in the report. The UE, in at least some embodiments, adjusts the measurement to indicate a stronger signal than the original measurement. The UE sends the early beam measurement report to the BS, which triggers the BS to switch to the expected beam earlier than it would without receiving the early beam measurement report. As such, the UE prevents the RLF from occurring at its current location.

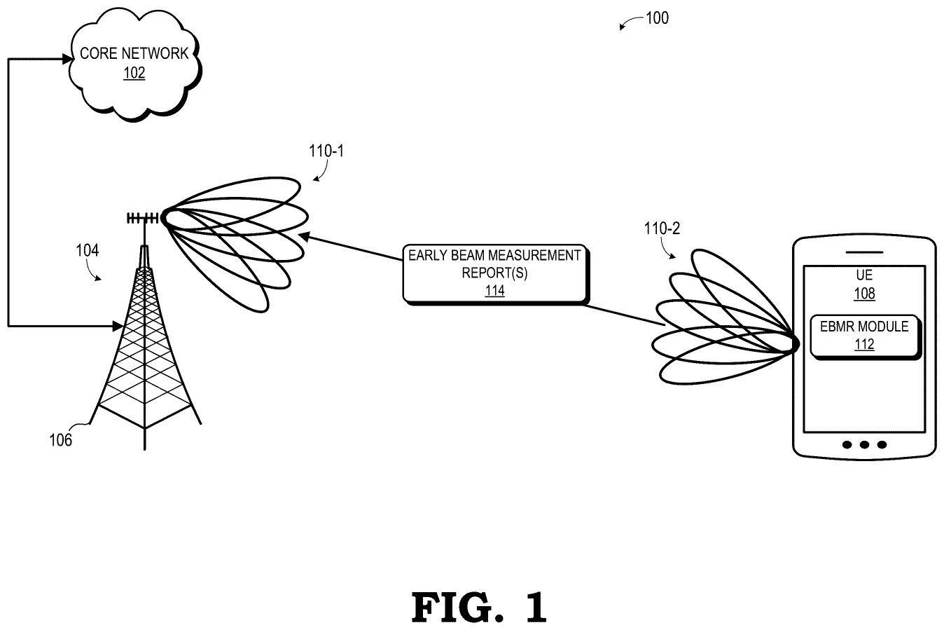

FIG. 1 illustrates a wireless communication network (mobile network) 100 employing fast beam switching based on early measurement reporting by a UE in accordance with some embodiments. As depicted, the wireless communication network 100 (network 100) includes a core network 102 coupled to one or more wide area networks (WANs) or other packet data networks (PDNs) (not illustrated), such as the Internet, Internet protocol multimedia subsystem (IMS) network, and so on. The core network 102 is further connected to one or more edge networks 104 via one or more backhaul networks (not shown). Each edge network 104 (also commonly referred to as a “cell” or a “radio access network” (RAN)) represents a corresponding fixed or mobile coverage area and includes at least one base station (BS) 106 to wirelessly communicate with one or more UEs 108 via radio frequency (RF) signaling using one or more applicable radio access technologies (RATs) as specified by one or more communications protocols or standards. As such, the BS 106 operates as the wireless interface between each UE 108 and various networks and services provided by the core network 102 and other networks, such as packet-switched (PS) data services, circuit-switched (CS) services, and the like.

The BS 106 can employ any of a variety of RATs, such as operating as a NodeB (or base transceiver station (BTS)) for a Universal Mobile Telecommunications System (UMTS) RAT (also known as “3G”), operating as an enhanced NodeB (eNodeB) for a 3GPP Long Term Evolution (LTE) RAT, operating as a 5G node B (“gNB”) for a 3GPP Fifth Generation 5G NR RAT, and the like. The UE 108, in turn, can implement any of a variety of electronic devices operable to communicate with the base station 106 via one or more suitable RATs, including, for example, a cellular phone, a cellular-enabled tablet computer or cellular-enabled notebook computer, a cellular-enabled wearable device, an automobile, or other vehicle employing cellular services (e.g., for navigation, provision of entertainment services, in-vehicle mobile hotspots, etc.), and so on.

The particular RAT used for wireless communications between the base station 106 and a UE 108 may rely on directional beamforming to generate and transmit one or more beams 110 (illustrated as beams 110-1 and beams 110-2) for providing more effective signal transmission, such as is implemented in 5G NR RATs, and in particular, for mmWave-based 5G NR signaling. However, one or more of the UEs 108 served by the base station 106 is “mobile” in that its location can, and typically does change relative to the base station 106, relative to the other UEs 108, or both. This mobility of certain UEs 108 can frustrate the use of highly directional RF communication links (e.g., beams 110) between transmitter and receiver implemented for mmWave and THz frequency bands as a mobile UE 108 changing location can result in misalignment in beam directions between the mobile UE 108 and the BS 106 (or another network component) in communication with the mobile UE 108. To mitigate this, the network 100 employs beam management techniques, such as beam tracking and beam switching, to ensure the UE 108 and the BS 106 maintain an optimal beam as the UE 108 roams across the network 100.

A typical mechanism implemented by the wireless communication network 100 for performing beam tracking and beam switching is aperiodic channel status information (CSI) reporting. Aperiodic CSI reporting involves the BS 106 configuring the UE 108, at irregular intervals or on-demand, to perform and report measurements on synchronization signal block (SSB) beams or a specific set of narrower CSI reference signal (RS) beams. As part of the CSI reporting process, the UE 108 reports the identity of the strongest beam(s) in combination with a radio signal received power (RSRP) measurement. For example, if the UE 108 is configured to generate an SSB-RSRP based CSI report, the UE 108 reports the identity (SSB index) of the strongest SSB beam(s) in combination with an SSB-RSRP measurement associated with the SSB beam(s). In another example, if the UE 108 is configured to generate a CSI-RS RSRP based CSI report, the UE 108 reports the identity (e.g., the CSI-RS resource indicator (CRI)) of the strongest CSI-RS beam(s) in combination with an RSRP measurement (CRI-RSRP) associated with the CSI-RS beam(s).

A CSI-ReportConfig (or similar) message can be used by the BS 106 to configure/instruct the UE 10 to perform CSI reporting. For example, if mobility of the UE 108 is to occur between synchronization signal/physical broadcast channel (SS/PBCH) beams, the CSI-ReportConfig message can configure the UE 108 to generate CSI reports with the reportQuantity parameter set to “ssb-Index-RSRP”. If mobility of the UE 108 is to occur between CSI reference signal beams, the CSI-ReportConfig message can configure the UE 108 to generate CSI reports with the reportQuantity parameter set to “cri-RSRP”. In at least some instances, the CSI-ReportConfig (or similar) message is transmitted to the UE 108 by the BS 106 over a physical downlink control channel (PDCCH). The UE 108 detects the CSI-ReportConfig (or similar) message by monitoring the PDCCH for downlink control information (DCI) having the format 0_1 and scrambled with an identifier (ID) associated with the UE 108. The BS 106 receives the CSI reports from the UE 108 identifying the strongest beam(s) and uses this information to switch between downlink (DL) beams. The BS 106 typically notifies the UE 108 through the PDCCH when the BS 106 is going to change the DL beam. When UE 108 receives the beam switch information, e.g., from DCI through PDCCH, the UE 108 changes its corresponding receive beam accordingly and sends an acknowledgment to the BS 106. The acknowledgment signals to the BS 106 that the beam switching instruction has been received by the UE 108. The BS 106 then switches the DL beam in response to receiving the acknowledgment from the UE 108.

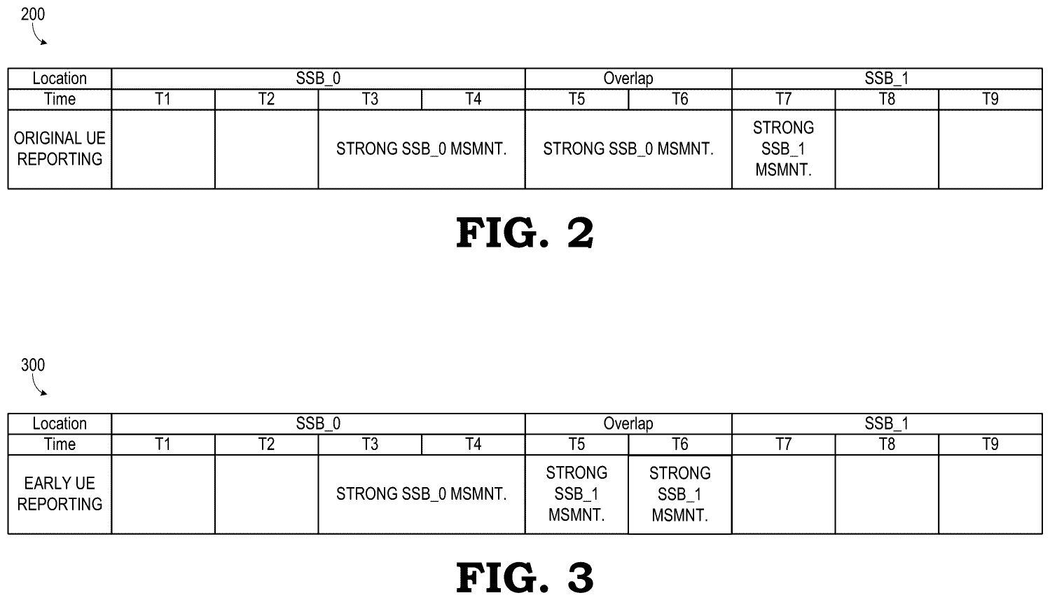

Although current wireless communication networks implement beam tracking procedures, the BS 106 may not switch to an appropriate DL beam in enough time to prevent a radio link failure while the UE 108 is mobile. For example, consider a common scenario in which the UE 108 is currently being served by a first SSB (e.g., SSB_0) and travels in a path/direction that will traverse at least a second (neighboring) SSB (e.g., SSB_1). In this example, the UE 108 is in the coverage area of SSB_0 during the time interval T1 to T4, as illustrated in the diagram 200 of FIG. 2. The UE 108 is configured by a component of the network 100, such as the BS 106, to generate and transmit a beam measurement report (e.g., a CSI report), report during time interval T3 to T4 indicating SSB_0 is the strongest beam. As the UE 108 continues to travel along the path, the UE 108, at time interval T5 to T6, enters an area where SSB_0 and SSB_1 overlap and SSB_1 is the optimal beam. For example, although SSB_0 may have a higher RSRP than SSB_1 in the overlapping area, SSB_1 is experiencing less noise (e.g., lower signal-to-interference-plus-noise-ratio (SINR) than SSB_0. Therefore, because the UE 108 is traveling away from the coverage area of SSB_0 and towards the coverage area of SSB_1, SSB_1 is the optimal beam in the overlapping coverage area.

However, based on conventional CSI reporting mechanisms, the UE 108 continues to report that SSB_0 is the strongest beam in the overlapping area at T5 and T6 and does not report SSB_1 as the strongest beam until the UE 108 is in the non-overlapping coverage area of SSB_1 at time interval T7. As such, the BS 106 considers SSB_0 to be the optimal beam while the UE 108 is in the overlapping coverage area. Consequently, the BS 106 does not switch to beam SSB_1 until the BS 106 receives a new beam measurement report from the UE 108 when the UE 108 enters the non-overlapping coverage area of SSB_1 at time interval T7. This late beam switch results in the UE 108 experiencing an RLF in the overlapping coverage because SSB_0 is not strong enough or has too much noise to continue serving the UE 108 in the overlapping area.

Accordingly, in at least some embodiments, the UE 108 prevents RLF resulting from late beam switching at the BS 106 by employing one or more mechanisms, such as an early beam measurement reporting (EBMR) module 112 (FIG. 1), for performing early beam measurement reporting to the network 100 relating to beam switching. As described in greater detail below, the EBMR module 112 generates an early beam measurement report 114 (FIG. 1) that indicates to the BS 106 an expected (target) SSB with a strong power measurement value (e.g., RSRP value) when the UE 108 traveling along a route. For example, while the UE 108 is in the SSB_0 and SSB_1 overlapping area during time interval T5 to T6, the EBMR module 112 determines that the next expected beam is SSB_1. As a result, the EBMR module 112 reports “strong SSB_1” to the BS 106 (or another network component) at time intervals T5 and T6, as illustrated in the diagram 300 of FIG. 3. The BS 106 receives the early beam measurement report during time interval T5 to T6, compared to time interval T7 to T9, and switches the DL beam to SSB_1 while the UE 108 is still in the overlapping coverage area. As such, the UE 108 avoids an RLF in the overlapping coverage area. Examples of the time intervals T1 to T9 include time intervals that are multiples of 80 to 100 milliseconds (ms), although other time intervals are applicable as well.

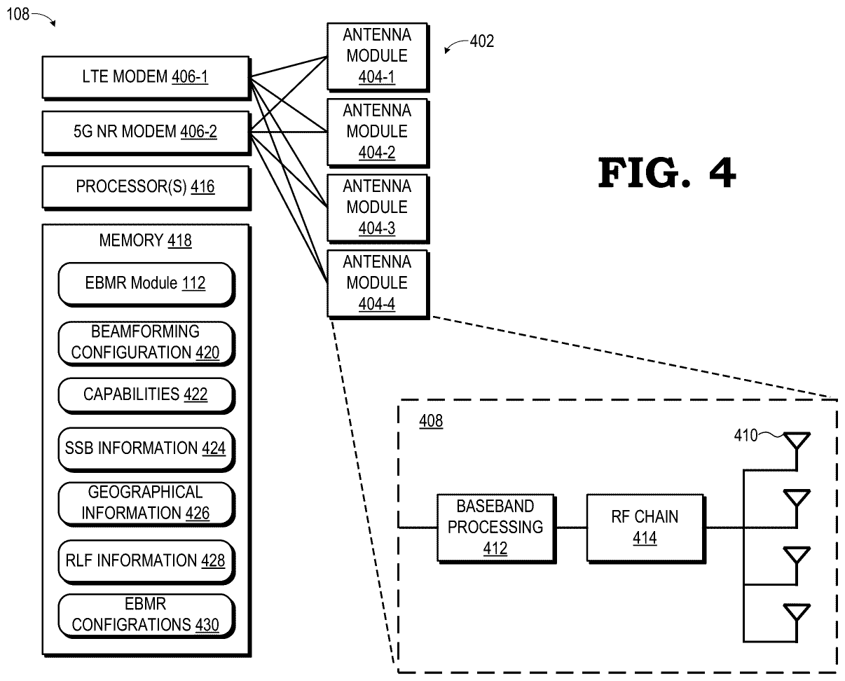

FIG. 4 illustrates an example hardware configuration for a UE 108 of the network 100 of FIG. 1 in accordance with some embodiments. Note that the depicted hardware configuration represents the processing components and communication components most directly related to early beam measurement reporting techniques for the UE 108 described herein and omit certain components well-understood to be frequently implemented in such electronic devices, such as displays, user input/output (I/O) devices, power supplies, and the like. In the depicted configuration, the UE 108 includes an RF front end 402 composed of an array of one or more antenna modules 404, such as the illustrated four antenna modules 404-1, 404-2, 404-3, and 404-4, and one or more wireless modems 406 implementing corresponding cellular protocols for conducting RF-based communications with the BS 106 and other base stations, such as an LTE modem 406-1 and a 5G NR modem 406-2. The RF front end 402 operates to conduct signals between the modems 406 and the array of antenna modules 404 to facilitate various types of wireless communication.

As illustrated by expanded window 408, each antenna module 404 implements a corresponding array of antenna elements 410, each excited by a corresponding feed RF signal when in a transmit (TX) mode and each excited by a received RF signal when in a receive (RX) mode. Each antenna element 410 is dimensioned and configured according to the expected frequency band(s) to be utilized for the antenna module 404, with mmWave and terahertz (THz) frequency bands particularly suited for the use of a larger array of small-dimensioned antenna elements due to the short wavelengths of RF signals at these frequencies. Note that although four antenna elements 410 are illustrated in the simplified example, in implementation, the number of antenna elements 410 in a given antenna module 404 often is substantially higher.

Typically, two variables are used for beamforming: amplitude and phase, such that for beamformed transmission, one or both of the amplitude or phase of a phase-coherent signal fed to a particular antenna element is shifted or otherwise adjusted relative to the phase-coherent signals fed to the other antenna elements, while for beamformed reception one or both of the amplitude or phase of a phase-coherent signal received via a particular antenna element is shifted or adjusted relative to the phase-coherent signals fed to the other antenna elements. The combination of the adjustments to phase and/or amplitude serves to “steer” the transmission beam of the RF signaling emitted by the antenna module or the reception beam of the RF signaling being monitored for reception by the antenna module in a manner that suppresses side lobes and steering nulls. To this end, each antenna module 204 may implement an analog beamforming transceiver architecture, a digital beamforming transceiver architecture, or a hybrid beamforming architecture as known in the art. For ease of illustration, the expanded window 408 illustrates an implementation of the antenna module 404-4 using an analog beamforming architecture having a single baseband processing module 412 and RF chain 14 for an array of antenna elements 410 and a phase shifter or delay line (omitted for clarity) for each antenna element 410 to implement a corresponding phase weight for each antenna element 410 to implement an indicated transmit beam or receive beam. As noted, a digital or hybrid architecture instead may be implemented, and the same or different beamforming architectures may be implemented at different antenna modules 404.

The UE 108 further includes one or more processors 416 and one or more non-transitory computer-readable media 418. The one or more processors 416 can include, for example, one or more central processing units (CPUs), graphics processing units (GPUs), an artificial intelligence (Al) accelerator, or other application-specific integrated circuits (ASIC), and the like. To illustrate, the processors 416 can include an application processor (AP) utilized by the UE 108 to execute an operating system and various user-level software applications, as well as one or more processors utilized by the modems 406. The computer-readable media 418 can include any of a variety or combinations of media used by electronic devices to store data and/or executable instructions, such as random-access memory (RAM), read-only memory (ROM), caches, registers Flash memory, solid-state drive (SSD) or other mass-storage devices, and the like. For ease of illustration and brevity, the computer-readable media 418 is referred to herein as “memory 418” in view of frequent use of system memory or other memory to store data and instructions for execution by the processor 416, but it will be understood that reference to “memory 418” shall apply equally to other types of storage media unless otherwise noted.

The one or more memories 418 of the UE 108 store one or more sets of executable software instructions and associated data that manipulate the one or more processors 416 and other components of the UE 108 to perform the various functions described herein and attributed to the UE 108. The sets of executable software instructions include, for example, an operating system (OS) and various drivers (not shown), various user software applications (not shown), and the EBMR module 112 that is configured to manipulate the one or more processors 416, the modems 406, the RF front end 402, or a combination thereof to perform the actions attributed to the EBMR processes described herein. In other embodiments, at least part of the EBMR module 112 is part of the modem 406 or distributed across one or more other components of the UE 108. In at least some embodiments, the data stored in the one or more memories 418 can include, for example, one or more beamforming configurations 420 received from the base station 106, beamforming capabilities data 422 identifying the various beamforming capabilities of the UE 108, SSB information 424 for early beam measurement reporting, geographical information 426 for early beam measurement reporting, RLF information 428, early beam measurement reporting configurations 430, and so on. In at least some embodiments, the SSB information 424 and the geographical information 426 are captured by the UE 108 as the UE travels within the network 100. Examples of SSB information 424 include identifiers (IDs) of the SSB beams encountered by the UE 108. Examples of geographical information 426 include global positioning system (GPS) information of the UE 108 and route information of the UE 108. RLF information 428 includes SSB information 424 and geographical information 426 associated with detected RLFs. The SSB information 424 stored as part of the RLF information 428 includes, for example, the IDs of the SSB beams used before and after an RLF. The geographical information 426 stored as part of the RLF information 428 includes, for example, GPS information of the UE 108 before, after, and/or during an RLF and also includes route information of the UE 108 associated with RLF.

It should be understood that the techniques described herein are not limited to GPS information, and other positioning techniques and information are applicable as well. For example, if the UE 108 is a vehicle (or a component in the vehicle), the EBMR module 112 can determine geographical information of the vehicle, such as the distance traveled, heading, speed/velocity, and the like, based on information provided by one or more components or sensors of the vehicle, historical travel information of the vehicle, and so on. The EBMR module 112 uses this information to determine, for example, the location of the vehicle and the route/path of the vehicle, and stores this information as part of the geographical information 426. Also, if the UE 108 is a device, such as a cellular phone, within a vehicle, the UE 108 can receive geographical information from the vehicle, such as distance traveled, heading, speed/velocity, and the like, so that the EBMR module 112 is able to determine a location of the UE 108 and record RLF events associated with a given location(s) even without GPS.

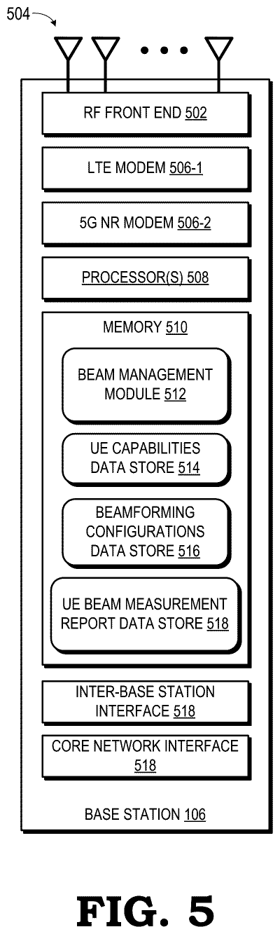

FIG. 5 illustrates a hardware configuration of the base station 106 of the network 100 in accordance with some embodiments. Note that the depicted hardware configuration represents the processing components and communication components most directly related to the role of the base station 106 in the UE early measurement reporting processes described herein and omit certain components well-understood to be frequently implemented in such electronic devices, such as displays, user input/output (I/O) devices, power supplies, and the like. Further note that although the illustrated diagram represents an implementation of the base station 106 as a single network node (e.g., a gNB), the functionality, and thus the hardware components, of the base station 106 instead may be distributed across multiple network nodes or devices and may be distributed in a manner to perform the functions described herein. As with the UE 108, the base station 106 includes an RF front end 502 composed of one or more antenna modules having one or more arrays of antenna elements, and one or more wireless modems, such as an LTE modem 506-1 and a 5G NR modem 506-2, for communicating with the UEs 108, as well as one or more processors 508 and one or more non-transitory computer-readable storage media 510 (as with the memory 418 of the UE 108, the computer-readable medium 510 is referred to herein as a “memory 510” for brevity). These components operate similarly as described above with reference to corresponding components of the UE 108.

The one or more memories 510 of the base station 106 store one or more sets of executable software instructions and associated data that manipulate the one or more processors 508 and other components of the base station 106 to perform the various functions described herein and attributed to the base station 106. The sets of executable software instructions include, for example, an operating system (OS) and various drivers (not shown), various software applications (not shown), and beam management module 512. The beam management module 512 configures the one or more processors 508, the modems 506, and the RF front end 502 to perform the actions attributed to the base station 106 in the beamforming and management process described herein. To that end, the data stored in the one or more memories 510 can include, for example, a UE capabilities data store 514, a beamforming configurations data store 516, and a UE beam measurement report data store 518. The UE capabilities data store 514 stores capability information for the UEs 108 attached to the base station 106, including beamforming capability information obtained from the UE 108. The beamforming configurations data store 516 stores a copy of each beamforming configuration provided to the UE 108. The UE beam measurement report data store 518 stores copies of UE beam measurement reports 114, such as CSI reports, received from the UE 108.

In some embodiments, the base station 106 further includes an inter-base station interface 520, such as an Xn or X2 interface, to exchange user-plane, control-plane, and other information between other base stations, and to manage the communication of the base station 106 with the UEs 108. The base station 106 further can include a core network interface 522 to exchange user-plane, control-plane, and other information with core network functions and/or entities.

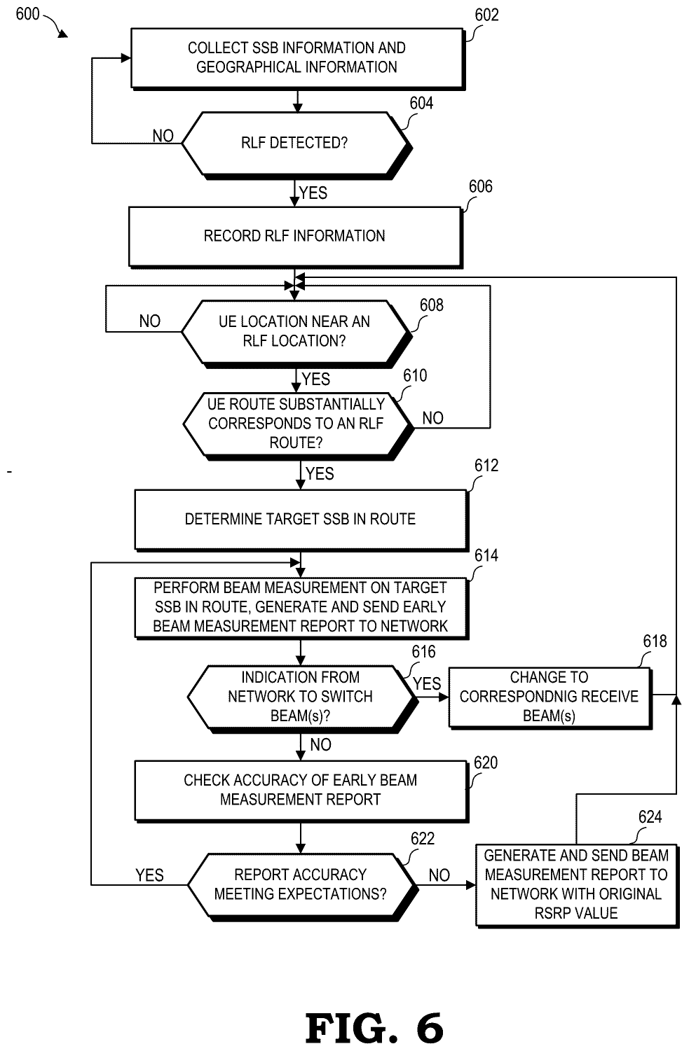

FIG. 6 illustrates an example method 600 for performing early beam measurement reporting by the UE 108 for beam switching in accordance with at least one embodiment. For illustration purposes, the method 600 is described in the example context of the network 100 of FIG. 1 and the hardware configurations for the UE 108 and the base station 106 of FIGS. 4 and 5, respectively. Moreover, although subprocesses of method 600 are illustrated and described in an example order, the method 600 is not limited to this particular order, and in some embodiments, certain processes may be performed in a different order, or concurrently rather than in sequential order, or may be omitted altogether. Also, although one or more processes of the method 600 are described with respect to the EBMR module 112, one or more other components of the UE 108, in at least some embodiments, are able to perform these processes.

The early beam measurement reporting process represented by method 600 starts after the UE 108 has already attached to the network 100 and is being served by one or more beams. At block 602, SSB information 424 and geographical information 426 collection processes are initiated or triggered at the UE 108. For example, as the UE 108 is mobile within the network 100, the EBMR module 112 collects SSB information 424, such as beam IDs, associated with the beams used, or at least detected, by the UE 108. In addition, the EBMR module 112 also collects geographical information 426, such as GPS information and route information of the UE 108, as the UE 108 travels throughout the network 100. In at least some embodiments, the EBMR module 112 is configured to collect the SSB information 424 and geographical information 426 in such a way that the EBMR module 112 is able to map SSB beams 110 to a route traveled by the UE 108 within the network 100. In other words, the EBMR module 112 is able to determine or predict which SSB beams 110 the UE 108 will encounter when traveling along (or near) a previously traversed route/path based on the SSB information 424 and geographical information 426.

The EBMR module 112, at block 604, monitors for an RLF. If an RLF has not occurred, the EBMR module 112 continues to monitor for an RLF. At block 606, if an RLF has occurred, such as in the example described above with respect to FIG. 2 and FIG. 3, the EBMR module 112 records the associated SSB information 424 and geographical information 426 as RLF information 428. For example, the recorded SSB information 424 includes the IDs of the SSB beams 110 used by the UE 108 before and after the RLF, and the geographical information 426 includes GPS and route information of the UE 108 before, after, and/or during a radio link failure. In at least some embodiments, the UE 108 continually performs the processes at blocks 602 to 606 or periodically repeats these processes.

At block 608, the UE 108 continues to travel within the network 100, and the EBMR module 112 determines if the UE's current position is at or near a location where the UE 108 previously experienced an RLF. For example, the EBMR module 112 compares the current geographical information 426 of the UE 108 to geographical information 426 recorded by the UE 108 when an RLF was detected. If the UE's current location does not substantially correspond (e.g., within a given distance threshold) to a previous RLF location, the EBMR module 112 continues to monitor the UE's location. In at least some embodiments, the threshold distance depends on one or more conditions, such as the distance of the UE 108 to the BS 106. In one example, if the UE 108 is close to the BS 106, the threshold distance may be less than 10 meters, and possibly approximately 3 meters, although other threshold distances are applicable as well. In another example, if the UE 108 is farther out from the BS 108, where the beam is wider, the threshold distance may be more than 30 meters. If the UE 108 is even farther away from the BS 106, the threshold distance may be more than 100 meters, although other threshold distances are applicable as well.

At block 610, if the UE's current location substantially corresponds (e.g., within a given distance threshold) to a previous RLF location, the EBMR module 112 determines if the UE's 108 current route substantially corresponds to a previously traversed route associated with the RLF location. For example, the EBMR module 112 compares the current route of the UE 108 to the route information (RLF route) recorded by the UE 108 when the RLF was detected. In at least some embodiments, the geographical information 426 performs the process at block 610 prior or concurrently with the process at block 608. If the current route of the UE 108 does not substantially correspond to the RLF route, the EBMR module 112 continues to monitor the UE's location and route. At block 612, if the current route of the UE 108 substantially corresponds to the RLF route, the EBMR module 112 determines that an RLF is likely to occur and determines the next SSB beam 110 expected to serve the UE 108 along the current route. For example, based on the SSB information 424, the EBMR module 112 determines that the current SSB beam is SSB_0 and the next SSB beam expected to be detected by the UE 108 along the current route is SSB_1.

At block 614, the EBMR module 112 generates an early beam measurement report 114 and transmits the report 114 to the BS 106. In this instance, the measurement report 114 is referred to as an “early beam measurement report” because the UE 108 generates and transmits the report 114 during a time interval prior to the time at which the RLF previously occurred. For example, as described above regarding FIG. 2 and FIG. 3, the UE 108 experiences an RLF during time interval T5 to T6 since the BS 106 did not switch to SSB_1 until at least time interval T7. However, the UE 108 knows that an RLF is likely to occur during time interval T5 to T6 or shortly thereafter based on the RLF information 428. Therefore, the UE 108 generates and transmits an early beam measurement report 114 during time interval T5 to T6 to trigger the BS 106 to switch to the target beam 110, e.g., SSB_1, prior to the RLF occurring.

In at least some embodiments, the early beam measurement report 114 includes a stronger power measurement for the target SSB. For example, if the EBMR module 112 determines that the current SSB of the UE 108 is SSB_0 and the next SSB expected to be encountered by the UE 108 is SSB_1, the EBMR module 112 adjusts (increases or decreases) the measured RSRP value of SSB_1 by a given amount. In at least some embodiments, the EBMR module 112 determines how to adjust the measured RSRP value of the target SSB based on one or more early measurement reporting configurations 430. In one configuration, the EBMR module 112 adds a predetermined decibel (dB) value to the measured RSRP value of the target SSB. If the adjusted RSRP value does not trigger the BS 106 to switch to the target SSB, the EBMR module 112 increases the adjusted RSRP value by a predetermined amount. In another configuration, the EBMR module 112 initially adds a maximum dB value to the measured RSRP of the target SSB. If the adjusted RSRP value does not trigger the BS 106 to switch to the target SSB, the EBMR module 112 decreases the adjusted RSRP value by a predetermined amount. In a further configuration, the EBMR module 112 adds a fixed dB value from a range of dB values to the measured RSRP.

At block 616, the EBMR module 112 determines if the BS 106 has indicated a switch to the target SSB (e.g., SSB_1) using one or more known mechanisms. At block 618, if the BS 106 has indicated a switch to the target SSB, the UE 108 proceeds to change its corresponding receive (RX) beam accordingly. The process then returns to block 608. At block 620, if the BS 106 has not indicated a switch to the target SSB, the EBMR module 112 checks the accuracy of the early beam measurement report 114.

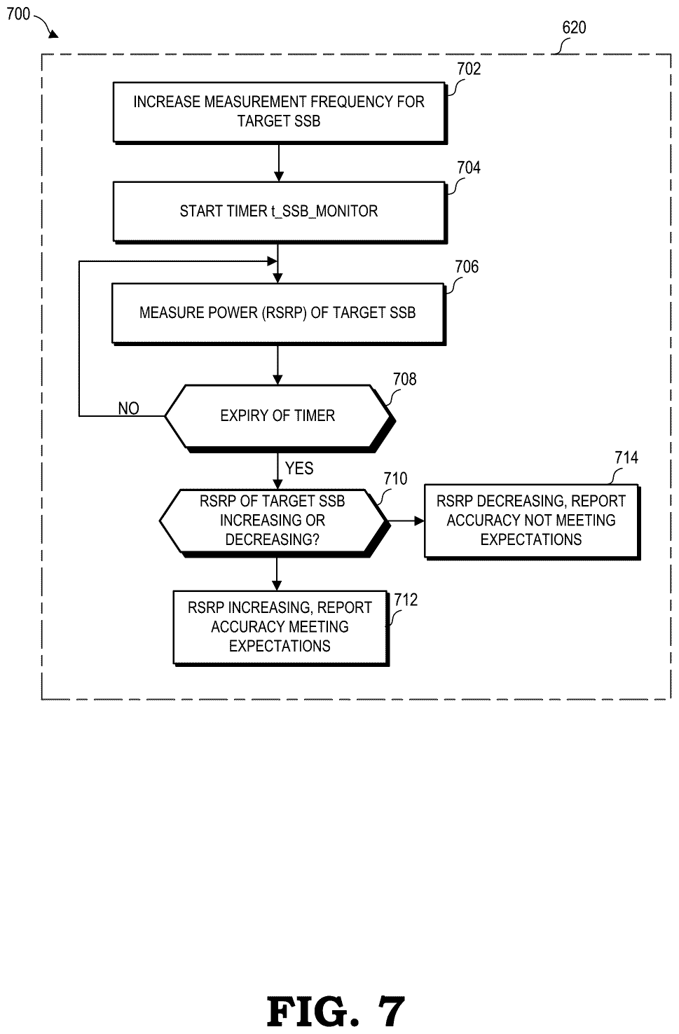

FIG. 7 illustrates an example method 700 for checking the accuracy of the early beam measurement report 114 in accordance with at least one embodiment. In this example process, the EBMR module 112 increases the measurement frequency for the target SSB (e.g., SSB_1) at block 702. In at least some embodiments, the EBMR module 112 increases the measurement frequency for the target SSB by reducing the number of SSBs that the UE 108 measures and limiting the measurements to the target SSB and, in at least some embodiments, the serving SSB (e.g., SSB_0). At block 704, the EBMR module 112 starts a timer (e.g., t_SSB_monitor) for a measurement monitoring period. At block 706, the EBMR module 112 measures the power of the target SSB. At block 708, the EBMR module 112 determines if the timer has expired. If the timer has not expired, the EBMR module 112 performs another power measurement for the target SSB. At block 710, if the timer has expired, the EBMR module 112 compares the power measurements to each other and/or the adjusted power measurement of the target SSB and determines if the RSRP of the target SSB is increasing or decreasing (conditions). At block 712, if the RSRP of the target SSB is increasing, the EBMR module 112 determines that the early beam measurement report is meeting accuracy expectations. At block 714, if the RSRP of the target SSB is decreasing, the EBMR module 112 determines that the early beam measurement report is not meeting accuracy expectations.

Returning to FIG. 6, at block 622, the EBMR module 112 determines if the accuracy of the early beam measurement report 114 is meeting expectations, as described above with respect to the method 700 of FIG. 7. If the early beam measurement report 114 is meeting expectations, which indicates the UE 108 is still traveling towards the target SSB, the process returns to block 614. The EBMR module 112 generates another early beam measurement report 114 and transmits the report 114 to the BS 106. In at least some embodiments, the EBMR module 112 uses one or more techniques to generate an early beam measurement report 114 comprising an updated adjusted measured RSRP value of the target SSB. For example, if the EBMR module 112 previously added a predefined RSRP value to the original RSRP value of the target SSB, the EBMR module 112 increases the adjusted RSRP value by a given amount (e.g., 1 dB). In at least some embodiments, the EBMR module 112 increases the original RSRP value up to a maximum amount (e.g., 3 dB). In another example, the EBMR module 112 updates the adjusted RSRP value of the target SSB by decreasing the adjusted RSRP value by a given amount (e.g., 1 dB). In at least some embodiments, the EBMR module 112 reduces the RSRP value until the difference between the initial adjusted RSRP value and the original RSRP value is at a minimum threshold amount (e.g., 1 dB).

At block 624, if the early beam measurement report 114 is not meeting expectations, which indicates the UE 108 is not traveling towards the target SSB, the EBMR module 112 generates a beam management report including the original measurement of one or both of the serving SSB (e.g., SSB_) or the serving SSB (e.g., SSB_1) such that the BS 106 does not perform an early switch to the target SSB. The process then returns to block 608. In at least some embodiments, the EBMR module 112 repeats the processes at block 608 to block 624 and implements a different technique (e.g., early measurement reporting configurations 430) for generating the early beam measurement report 114. If the EBMR module 112 has performed all available techniques for generating the early beam measurement report 114 and the early beam measurement report 114 is still not meeting expectations, the process returns to block 602. The EBMR module 112, in at least some embodiments, maintains information indicating which technique(s) for generating the early beam measurement report 114 was successful or unsuccessful in meeting expectations for the associated location or route. In at least some embodiments, the EBMR module 112 uses this information to, for example, determine which early measurement reporting configuration 430 to implement when the UE 108 subsequently encounters the associated location/route or other locations/routes.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified, and all such variations are considered within the scope of the disclosed subject matter. Accordingly, the protection sought herein is as set forth in the claims below.

1. A method by a user equipment (UE) in a cellular network, comprising:
determining that a radio link failure (RLF) has previously occurred within a threshold distance from a current location of the UE;
responsive to determining that the RLF has previously occurred, determining an expected beam to be encountered by the UE and associated with the RLF;
generating a first beam measurement report for the expected beam, the first beam measurement report including an adjusted power measurement for the expected beam; and
transmitting the first beam measurement report to the cellular network.

2. The method of claim 1, wherein the determining of the expected beam is further in response to determining that a current route of the UE substantially corresponds to route information recorded by the UE when the RLF previously occurred.

3. The method of claim 1, wherein the first beam measurement report is generated and transmitted to the cellular network during a time interval that is prior to a time interval during which a beam measurement report for the expected beam is generated and transmitted when the RLF has not occurred.

4. The method of claim 1, wherein generating the first beam measurement report comprises one of:
increasing an original power measurement by a predefined incremental value to obtain the adjusted power measurement;
increasing the original power measurement by a predefined maximum value to obtain the adjusted power measurement; or
increasing the original power measurement by a fixed value to obtain the adjusted power measurement.

5. The method of claim 1, wherein generating the first beam measurement report comprises:
adjusting the adjusted power measurement for the expected beam to indicate that the expected beam is more optimal than neighboring beams.

6. The method of claim 1, further comprising:
responsive to transmitting the first beam measurement report to the cellular network, determining a base station has indicated a beam switch to the expected beam; and
changing a receive beam to the expected beam.

7. The method of claim 1, further comprising:
responsive to determining that a base station has not indicated a beam switch, checking an accuracy of the first beam measurement report.

8. The method of claim 7, wherein checking the accuracy of the first beam measurement report comprises increasing a measurement frequency of the expected beam.

9. The method of claim 8, wherein increasing a measurement frequency of the expected beam comprises reducing a number of synchronization signal blocks measured by the UE

10. The method of claim 8, wherein increasing a measurement frequency of the expected beam comprises:
initiating a timer; and
performing one or more power measurements for the expected beam prior to expiration of the timer.

11. The method of claim 7, further comprising:
responsive to the accuracy of the first beam measurement report satisfying one or more conditions, generating a second beam measurement report for the expected beam, the second beam measurement report including a further adjusted power measurement for the expected beam; and
transmitting the second beam measurement report to the cellular network.

12. The method of claim 7, further comprising:
responsive to the accuracy of the first beam measurement report failing to satisfy one or more conditions, generating a second beam measurement report for the expected beam comprising an original power measurement for the expected beam; and
transmitting the second beam measurement report to the cellular network.

13. The method of claim 11, wherein the one or more conditions include a condition that a power measurement of the expected beam is increasing.

14. (canceled)

15. A non-transitory computer-readable medium storing executable instructions configured to manipulate a processor of a user equipment to implement the method of claim 1.

16. A user equipment (UE) comprising:
an array of one or more antenna modules;
one or more modems coupled to the array;
one or more processors coupled to the one or more modems; and
one or more memories coupled to the one or more processors, the one or more memories storing instructions that, when executed, are configured to cause one or both of the one or more processors or the one or more modems to:
determine that a radio link failure (RLF) has previously occurred within a threshold distance from a current location of the UE;
responsive to determining that the RLF has previously occurred, determine an expected beam to be encountered by the UE and associated with the RLF;
generate a first beam measurement report for the expected beam, the first beam measurement report including an adjusted power measurement for the expected beam; and
provide the first beam measurement report for transmission to a cellular network via the array of one or more antenna modules.

17. The UE of claim 16, wherein the instructions configured to cause one or both of the one or more processors or the one or more modems to determine the expected beam are configured to cause the determining of the expected beam further in response to determining that a current route of the UE substantially corresponds to route information recorded by the UE when the RLF previously occurred.

18. The UE of claim 16, wherein the first beam measurement report is generated and transmitted to the cellular network during a time interval that is prior to a time interval during which a beam measurement report for the expected beam is generated and transmitted when the RLF has not occurred.

19. The UE of claim 16, wherein the instructions configured to cause one or both of the one or more processors or the one or more modems to generate the first beam measurement report comprise instructions configured to cause one or both of the one or more processors or the one or more modems to one of:
increase an original power measurement by a predefined incremental value to obtain the adjusted power measurement;
increase the original power measurement by a predefined maximum value to obtain the adjusted power measurement; or
increase the original power measurement by a fixed value to obtain the adjusted power measurement.

20. The UE of claim 16, wherein the instructions are further configured to cause one or both of the one or more processors or the one or more modems to:
responsive to transmitting the first beam measurement report to the cellular network, determine a base station has indicated a beam switch to the expected beam and change a receive beam to the expected beam; or
responsive to determining that a base station has not indicated a beam switch, checking an accuracy of the first beam measurement report.

21. The UE of claim 20, wherein checking the accuracy of the first beam measurement report comprises increasing a measurement frequency of the expected beam.

22. The UE of claim 21, wherein increasing a measurement frequency of the expected beam comprises at least one of: reducing a number of synchronization signal blocks measured by the UE; or initiating a timer and performing one or more power measurements for the expected beam prior to expiration of the timer.

23. The UE of claim 20, wherein the instructions are further configured to cause one or both of the one or more processors or the one or more modems to:
responsive to the accuracy of the first beam measurement report satisfying one or more conditions, generate a second beam measurement report for the expected beam, the second beam measurement report including a further adjusted power measurement for the expected beam; and
provide the second beam measurement report for transmission to the cellular network via the array of one or more antenna modules.

24. The UE of claim 20, wherein the instructions are further configured to cause one or both of the one or more processors or the one or more modems to:
responsive to the accuracy of the first beam measurement report failing to satisfy one or more conditions, generate a second beam measurement report for the expected beam comprising an original power measurement for the expected beam; and
providing the second beam measurement report for transmission to the cellular network via the array of one or more antenna modules.
